(19) United States
(12) Patent Application Publication
(10) Pub. No.: US 2025/0315864 A1
(43) Pub. Date: Oct. 9, 2025

(54) DETERMINING WHETHER TO PLACE AN ADVERTISEMENT REQUESTING AN ADDRESS

(71) Applicant: Dropbox, Inc., San Francisco, CA (US)

(72) Inventor: Andrew Donald Yates, San Francisco, CA (US)

(21) Appl. No.: 19/244,901

(22) Filed: Jun. 20, 2025

Related U.S. Application Data
(63) Continuation of application No. 18/104,768, filed on Feb. 1, 2023.
(60) Provisional application No. 63/305,579, filed on Feb. 1, 2022.

(51) Int. Cl. G06Q 30/0251; G06Q 10/083

(52) U.S. Cl. CPC G06Q 30/0271; G06Q 10/083

(57) ABSTRACT

Disclosed herein is a system and method to determine whether to place an advertisement to a user requesting an address from the user. The system can iteratively determine multiple advertisement metrics of multiple advertisements to obtain multiple metrics. An advertisement metric among the multiple advertising metrics can indicate the value of placing the advertisement to the user. The system can rank multiple advertisements based on the multiple advertisement metrics and present a predetermined percentage of top-ranking advertisements among the multiple advertisements.

### CROSS-REFERENCE TO RELATED APPLICATIONS

This application is a continuation of U.S. patent application Ser. No. 18/104,768, filed Feb. 1, 2023, which claims the benefit and priority to the U.S. Provisional Patent Application No. 63/305,579, filed on Feb. 1, 2022. Each of the aforementioned applications is hereby incorporated by reference in its entirety.

### BACKGROUND

Online advertising is a form of marketing and advertising which uses the Internet to promote products and services to audiences and platform users. Like other advertising media, online advertising frequently involves a publisher, who integrates advertisements into its online content, and an advertiser, who provides the advertisements to be displayed on the publisher's content. Traditionally, the engagement of the user with an advertisement included viewing the advertisement, or clicking on the advertisement.

### BRIEF DESCRIPTION OF THE DRA WINGS

Detailed descriptions of implementations of the present invention will be described and explained through the use of the accompanying drawings.

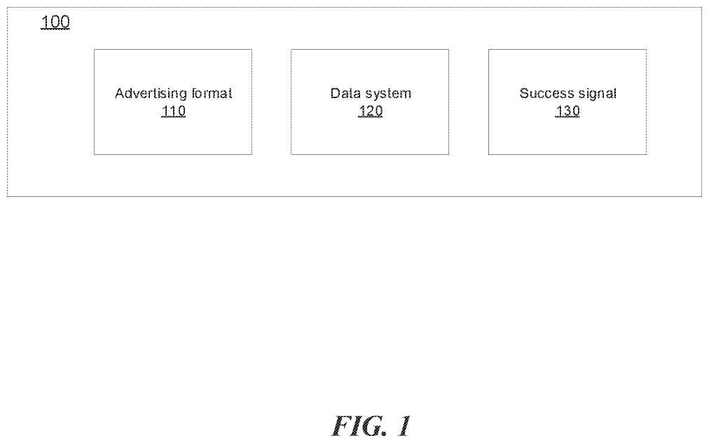

FIG. 1 shows three major components of an advertising system.

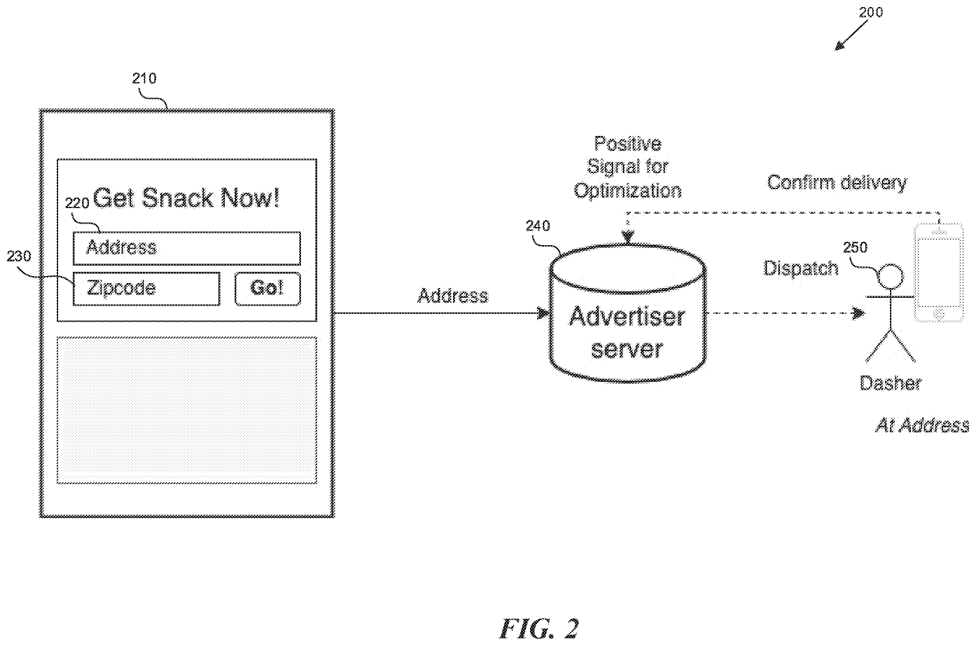

FIG. 2 shows a system for presenting an advertisement requesting a user address.

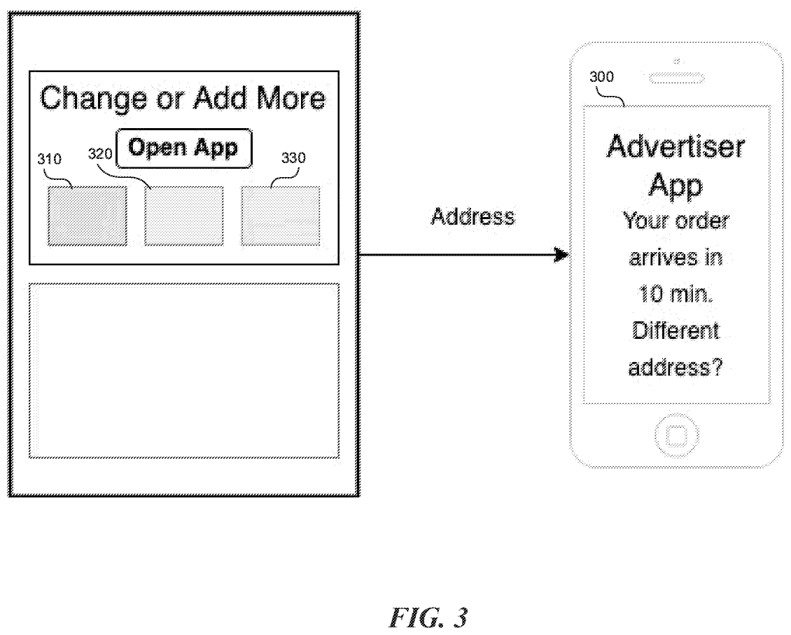

FIG. 3 shows a system for modifying a placed order.

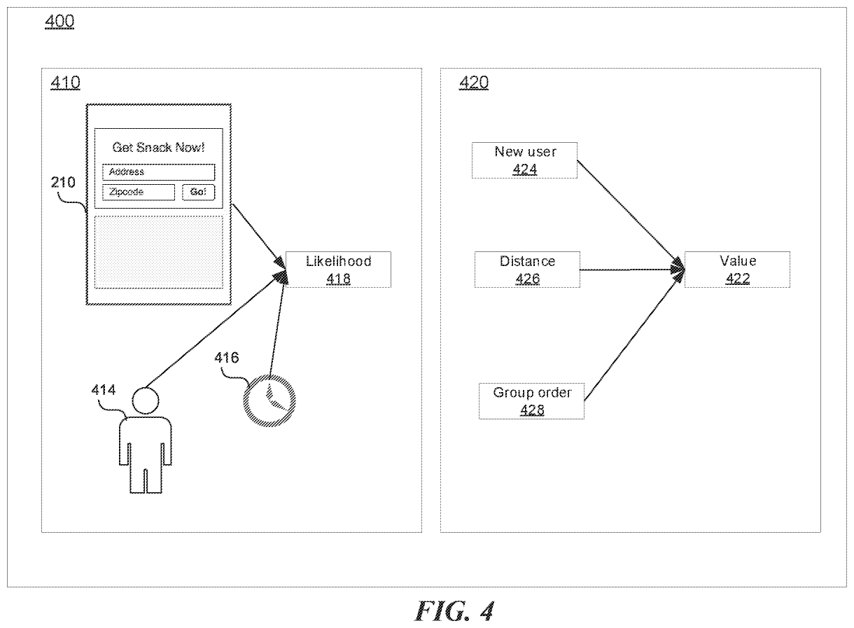

FIG. 4 shows a system to determine a value of an advertisement.

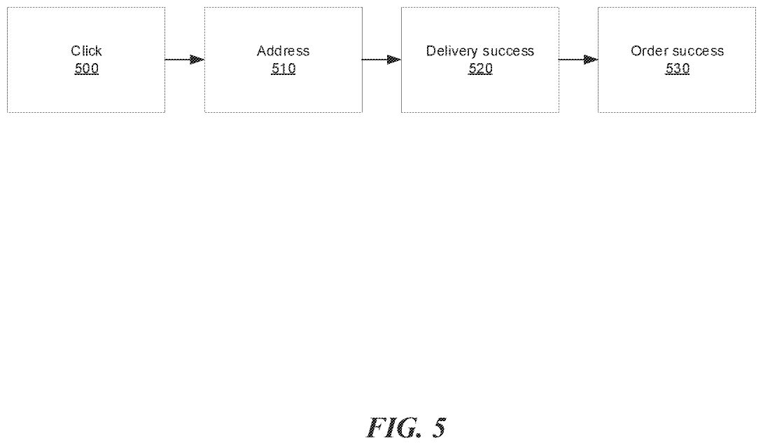

FIG. 5 shows use of proxies to determine a value of an advertisement.

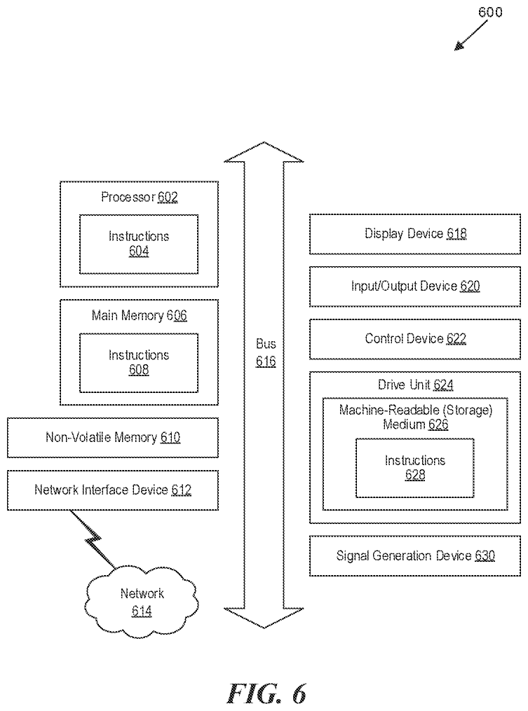

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein is a system and method to determine whether to place an advertisement to a user requesting an address from the user. The system can iteratively determine multiple advertisement metrics of multiple advertisements to obtain multiple metrics. An advertisement metric among the multiple advertising metrics can indicate the value of placing the advertisement to the user. The system can rank multiple advertisements based on the multiple advertisement metrics, and present a predetermined percentage of top-ranking advertisements among the multiple advertisements.

To determine which advertisements to present, the system can obtain multiple metrics indicating a value associated with the user. A first metric among the multiple metrics can indicate a value of a new user, such as $10. A second metric among the multiple metrics can indicate a value of a repeat user, such as $5. A third metric among the multiple metrics can indicate an impact of length of delivery to the user. For example, each additional minute of delivery time can reduce the value of the advertisement by $0.50.

The system can obtain a profile associated with the user, a time to present the advertisement to the user, and a content associated with the advertisement. The profile associated with the user can indicate how frequently the user makes online purchases, and/or the user's demographic information. The advertisement can include a request to enter the address at which to deliver an item. Based on the profile associated with the user, the time, and the content, the system can determine a likelihood that the user will enter the address into the advertisement when the advertisement including the content is presented to the user at the time. Based on the likelihood and the multiple metrics, the system can determine a fourth metric indicating a value associated with the advertisement to obtain multiple advertisement metrics associated with the multiple advertisements. As described above, based on the ranking, the system can present a certain percentage, such as top 10%, of the highest-ranking advertisements to the users.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Determining Whether to Place an Advertisement Requesting an Address

FIG. 1 shows three major components of an advertising system. The three major components can include: advertising format 110, data system 120, and a success signal 130. The system 100 can present an advertisement, described in this application, in an advertising format 110 on a publishing platform (“publisher”). The publisher can be the platform presenting the advertisement to the user, such as a new site, a blog site, a discussion website such as Reddit, etc. The advertiser can be the platform that determines which advertisements to present to which users. The provider can be a platform that commissions the placement of the advertisement, delivers the item to the user, and provides the application enabling the user to further interact with the provider.

The advertisement can collect the address of a user viewing the advertisement. The advertisement can directly solicit the user's address in the advertisement. In one embodiment, once the user enters the address into the advertisement, the system 100 can deliver an item, such as a snack, to the entered address. In another embodiment, if the system 100 already has the address, e.g., through the media company or publisher, then instead of showing the address box in the advertisement, the advertisement can present a button that when selected can provide a free item, such as a snack to the user at the address.

The data system 120 can collect the information from the advertisement and can share the collected information with the publisher and the advertiser. Based on the address, the data system 120 can estimate the value of delivering the item to the address. The data system 120 can consider distance between a nearest warehouse and the entered address, user information, context, etc. User information can include whether the user is a new user, if the user and is an existing user, total purchases from the user, etc. Context can include information such as if there are other users ordering items near the current user. The success signal 130 is a combination of a physical delivery and the address.

In one embodiment, once the user enters the address into the advertisement, the system can automatically download the application on the user's device, without requiring the user to manually download the application.

FIG. 2 shows a system for presenting an advertisement requesting a user address. The system 200 can present the advertisement 210 to a user on a third-party publishing platform. The user can enter the address and the ZIP code in the fields 220, 230, respectively. If the publisher has the user's address, the system 200 can pre-populate the fields 220, 230.

The advertisement 210 is different from the traditional advertisements in several ways. First, the advertisement requests user's address, and second, the advertisement can facilitate installation of the application associated with the provider. Traditionally, clicking on an advertisement can take the user to the provider's website, where the user has to download the application, and then the user needs to place the order in the application. In each of these steps, users tend to lose interest, and the number of users that actually download the application is small compared to the number of users that have selected the advertisement. By contrast, in the present case, the user needs to enter only the address in the advertisement 210. Once the address is entered, the user automatically receives the order, and in addition can automatically have the application installed. Alternatively, the dasher of the order can facilitate the installation of the application.

The advertisement 210 can send the address to the server 240, which in turn can dispatch a dasher 250 to the address. The dasher can be a person, or an autonomous aerial, terrestrial and/or hydro vehicle. The autonomous vehicle can include an autonomous aerial vehicle, such as a drone, an autonomous terrestrial vehicle, such as a car, and/or an autonomous hydro vehicle. Upon delivery, the dasher can notify the advertiser as well as the provider of the item that a successful delivery has been made. In addition, upon delivery the dasher can ensure that the user has installed the software application (“application”) associated with the provider of the item, and can notify the advertiser and the provider of the item that the application has been installed. If the user has not installed the software application, the dasher can offer assistance and installation.

The physical address is the identity connector between the media delivery, user engagement, and order fulfillment by the direct-response advertiser. Upon completing the delivery, the dasher 250 can confirm the delivery, and can also confirm installation of the application. The confirmation of the delivery and/or the confirmation of the installation of the application can be used as a success signal for that physical address. The system 200 can use the success signal for future advertisement optimization and event pricing, for example, by using the success signal for training machine learning (ML).

FIG. 3 shows a system for modifying a placed order. To modify the order, the user can download or open the provider's application 300 and can change the address, add or change payment method, and/or add items 310, 320, 330 to the order. The user can add more items 310, 320, 330 to the order by selecting more items either from the advertisement 210 in FIG. 2, or from a user interface associated with the application 300. A hardware or software processor associated with the application 300 and/or the advertisement 210, can send the unique identifier of the selected item to the server 240 in FIG. 2.

If the processor sends the modification to the placed order within a short period of time, such as before the originally ordered items were sent for delivery, the new items 310, 320, 330 can be added to the order. If the server 240 receives the modification after the original order has been delivered, the server 240 can generate a prompt to the user for a new order confirmation.

FIG. 4 shows a system to determine a value of an advertisement. The system can determine the value of the advertisement prior to placing the advertisement. The system 400 determining the value of an advertisement can include two parts 410, 420. First, the system 410 can determine the likelihood 418 that an event happens if the advertisement 210 is presented to the user 414 at a particular time 416. The system 410 can be an ML model trained on data from users similar to the user 414. The event that the system 410 is predicting can be selecting the advertisement 210, entering the address of the user, successful delivery, installation of the application, etc., as explained below.

Second, assuming that the event has happened, the system 420 can determine the value 422 of completing the action to the provider. Completing the action can include successful delivery, installation of the application, etc. The system 420 can be an ML trained on data from users similar to the user 414. The value 422 can be expressed in terms of benefit minus the cost.

To calculate the value, the system 420 can start with a default value for each user and adjust based on various parameters such as whether the user is a new user 424, distance to the user 426, group order 428, etc. For example, the system 420 can estimate that each user is worth $10. If the user 414 is a repeat purchaser then the repeat user 414 can be half as valuable as a new user, because the system 420 can treat new users as more valuable than existing users.

The system 400 can determine whether the user is new prior to placing the advertisement, or after the user enters the address. To determine whether the user is new after entering the address, the system 400 can determine whether the entered address is already in the system database. If the entered address is not in the system database, the system 400 can determine that the user is new. To determine whether the user is new prior to placing the advertisements, the system 400 can use location heuristics. For example, the system 400 can obtain the IP address of a device associated with the user. Based on the IP address, the system 400 can determine a general geographic location of the user such as the user is in San Francisco, or Seattle, or in Austin. In addition, the system 400 can determine if the user is sharing his location, and can determine the user's location based on location sharing. For example, location sharing can be accurate to within six meters. Based on location sharing and/or IP address, the system can determine whether the user is new within 80% accuracy. Even if the system incorrectly classifies a user as new with the 20% probability, that is an acceptable error rate for the system.

From a distance perspective, the system 420, for example, can determine that every minute of delivery is an extra dollar. So, once the value 422 of completing the action becomes $0, the action is never completed. In a more specific example, if delivering to a repeat user takes more than five minutes, completing the action becomes $0 or less, and the action is never completed.

In addition to distance, the system 420 can consider whether the order is a group order 428 and/or can be combined with another order, in which case the distance to the particular user can be reduced. For example, if the system 420 is already delivering an order to a second user within two minutes to the first user, the cost of delivering to the first user is only $2, even though the distance from the distribution center to the first user is 15 minutes.

To determine the value 422 of completing the action, the system 420 can obtain values from the provider that indicate, in dollar amounts, the value of the new user, the value of a repeat user, the cost for every minute of delivery, etc. The values can vary based on location of the user.

To determine the value of placing an advertisement 210, the system 400 can combine how likely the event is with how valuable completing the action is. For example, if the likelihood that the user enters the address is 0.5, and the value of delivering the snack to the address is $5, the value of the advertisement 210, prior to presenting the advertisement to the user is $2.50. In another example, if the likelihood that the user enters the address is 0.9, and the value of delivering the snack to the address is $8 the value of the advertisement is $7.20. The system 400 can compare the values of the advertisements, rank them, and present the advertisements having the highest value.

The system 420 can optimize for successful delivery. Successful delivery can have few criteria such as whether the address is valid, whether the item was successfully delivered, whether the user 414 has installed the application, whether the user has made an additional purchase, etc. The system 420 can optimize for one or more of the successful delivery criteria.

FIG. 5 shows use of proxies to determine a value of an advertisement. The final objective of the system 400 in FIG. 4 is to determine lifetime value of a user. However, a lifetime timeline is difficult to measure. Instead of the lifetime timeline, the system 400 determines proxies 500, 510, 520, 530 representing events that are more frequent and happen sooner.

Proxy 500, “click,” can indicate that the user has selected the advertisement 210 in FIGS. 2, 4. Proxy 510, “address,” can indicate that the user has entered the address into the advertisement 210. Proxy 520, “delivery success,” can indicate that the dasher has made a successful delivery. Proxy 530, “order success,” can indicate that the user has successfully installed the application. Order success 530 can include successful installation of the provider's application 300 in FIG. 3.

The amount of data available in each proxy 500, 510, 520, 530 reduces from left to right because for the rightmost event 530 to happen, namely, order success, all the events 500, 510, 520 need to have happened already. From a machine learning perspective, the more data to train, the better the machine learning model, and consequently systems 410, 420 in FIG. 4 can use proxies 500 or 510 to determine the likelihood that events 520 and/or 530 happen. In addition, the system 400 can determine correlation between events 500, 510, 520, 530. The correlation is positive and can be factored into the value of the advertisement. For example, if the system 420 optimizes for proxy 500 but, in reality, the system would like to optimize for proxy 530, the system 420 can determine that the correlation between proxy 500 and 530 is 0.7. Consequently, when the system 420 determines the value of the advertisement based on proxy 500, the value of the advertisement can be multiplied by 0.7, that is, the correlation between proxy 500 and 530.

The proxies 500, 510, 520, 530 are easier to optimize for, but they are proxies and not exactly representative of the lifetime value of the user. To cure this issue, the system 400 can optimize for a proxy, as well as the less frequent event that the system is actually interested in. For example, the system 400 can be optimizing for the successful delivery 520. However, because successful delivery 520 is a less frequent event than clicking on an advertisement 500, the system can optimize for both the clicking on an advertisement 500 and the successful delivery 520. The system 400 can track the proxy events 500, 510, 520, 530 as they are happening, and as the successful delivery 520 becomes more likely, the value of completing the delivery can increase.

### Computer System

FIG. 6 is a block diagram that illustrates an example of a computer system 600 in which at least some operations described herein can be implemented. As shown, the computer system 600 can include one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the Figures and any other components described in this specification can be implemented.

The computer system 600 can take any suitable physical form. For example, the computing system 600 can share a similar architecture as that of a server computer, personal computer, tablet computer, mobile telephone, game console, music player, wearable electronic device, network-connected “smart” device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip, a single-board computer system or a distributed system such as a mesh of computer systems, or can include one or more cloud components in one or more networks. Where appropriate, one or more computer systems 600 can perform operations in real time, near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, or machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A computer-implemented method comprising:
accessing content value data for presenting interactive content, the content value data comprising one or more of account profile information, a content time value, and a content value;
generating, utilizing a machine learning model, a content interaction prediction by predicting a series of client device interactions with the interactive content according to the content value data;
generating a combined content value prediction by adjusting the content interaction prediction according to a content fulfillment value prediction corresponding to a value of completing an action associated with the interactive content; and
providing the interactive content for display on a client device based on the combined content value prediction.

2. The computer-implemented method of claim 1, wherein accessing content value data comprises determining, for the account profile information, one or more of a content interaction frequency value or an account profile demographic value.

3. The computer-implemented method of claim 1, wherein generating the content interaction prediction comprises:
generating one or more content interaction proxy predictions comprising an initial content interaction proxy prediction, a content destination interaction proxy prediction, a content delivery proxy prediction, or a content installation proxy prediction; and
combining the one or more content interaction proxy predictions.

4. The computer-implemented method of claim 3, wherein combining the one or more content interaction proxy predictions comprises:
determining, utilizing the machine learning model, correlation values corresponding to the one or more content interaction proxy predictions; and
combining the one or more content interaction proxy predictions according to the correlation values.

5. The computer-implemented method of claim 1, wherein generating the combined content value prediction comprises:
generating a default content fulfillment value prediction;
generating the content fulfillment value prediction by adjusting the default content fulfillment value prediction according to the content value data; and
utilizing the content fulfillment value prediction to adjust the content interaction prediction.

6. The computer-implemented method of claim 1, further comprising:
generating a plurality of combined content value predictions corresponding to a plurality of interactive content;
generating a ranking of the plurality of combined content value predictions;
selecting an interactive content from the plurality of interactive content according to the ranking of the plurality of combined content value predictions; and
providing the selected interactive content for display on the client device.

7. The computer-implemented method of claim 1, further comprising installing an application associated with the interactive content in response to the client device interacting with the interactive content.

8. A system comprising:
at least one processor; and
at least one non-transitory computer-readable storage medium storing instructions that, when executed by the at least one processor, cause the system to:
generate, utilizing a machine learning model, a content interaction prediction by predicting a series of client device interactions with interactive content according to content value data associated with a client account;
generate a combined content value prediction by adjusting the content interaction prediction according to a content fulfillment value prediction corresponding to a value of completing an action associated with the interactive content; and
provide the interactive content for display on a client device based on the combined content value prediction.

9. The system of claim 8, further comprising instructions that, when executed by the at least one processor, cause the system to determine, for the content value data associated with a client account, one or more of a content interaction frequency value or an account profile demographic value.

10. The system of claim 8, further comprising instructions that, when executed by the at least one processor, cause the system to generate the content interaction prediction by combining one or more content interaction proxy predictions corresponding to one or more proxy predictions corresponding to interaction with the interactive content.

11. The system of claim 10, further comprising instructions that, when executed by the at least one processor, cause the system to combine the one or more content interaction proxy predictions by selectively weighting the one or more content interaction proxy predictions according to correlation values determined by the machine learning model.

12. The system of claim 8, further comprising instructions that, when executed by the at least one processor, cause the system to generate the combined content value prediction by:
generating the content fulfillment value prediction by adjusting a default content fulfillment value prediction according to the content value data; and
utilizing the content fulfillment value prediction to adjust the content interaction prediction.

13. The system of claim 8, further comprising instructions that, when executed by the at least one processor, cause the system to:
generate a second combined content value prediction corresponding to a second interactive content;
generate a ranking of the combined content value prediction and the second combined content value prediction; and
select the second interactive content for display on the client device in response to determining that the second combined content value prediction exceeds the combined content value prediction.

14. The system of claim 8, further comprising installing an application associated with the interactive content in response to a client device interacting with the interactive content.

15. A non-transitory computer-readable medium storing instructions that, when executed by at least one processor, cause a computer system to:
access content value data for presenting interactive content, the content value data comprising one or more of account profile information, a content time value, and a content value;
generate, utilizing a machine learning model, predictions for a series of client device interactions with the interactive content according to the content value data;
generate, utilizing the machine learning model, a content interaction prediction by combining the predictions for a series of client device interactions;
generate a combined content value prediction by adjusting the content interaction prediction according to a content fulfillment value prediction corresponding to a value of completing an action associated with the interactive content; and
provide the interactive content for display on a client device based on the combined content value prediction.

16. The non-transitory computer-readable medium of claim 15, further comprising instructions that, when executed by the at least one processor, cause the computer system to access content value data by:
accessing a client account associated with the account profile information; and
determining, for the client account, one or more of a content interaction frequency value or an account profile demographic value.

17. The non-transitory computer-readable medium of claim 15, further comprising instructions that, when executed by the at least one processor, cause the computer system to generate predictions for a series of client device interactions by:
determining one or more client device interaction proxies; and
generating one or more content interaction proxy predictions corresponding to the one or more client device interaction proxies.

18. The non-transitory computer-readable medium of claim 15, further comprising instructions that, when executed by the at least one processor, cause the computer system to generate the combined content value prediction by:
generating the content fulfillment value prediction by adjusting a default content fulfillment value prediction according to the content value data; and
utilizing the content fulfillment value prediction to adjust the content interaction prediction.

19. The non-transitory computer-readable medium of claim 15, further comprising instructions that, when executed by the at least one processor, cause the computer system to:
generate a plurality of combined content value predictions corresponding to a plurality of interactive content;
determine a subset of combined content value predictions corresponding to a subset of interactive content by comparing the plurality of combined content value predictions to an interactive content value threshold;
generating a ranking of the subset of combined content value predictions;
selecting an interactive content from the subset of interactive content according to the ranking of the subset of combined content value predictions; and
providing the selected interactive content for display on the client device.

20. The non-transitory computer-readable medium of claim 15, further comprising instructions that, when executed by the at least one processor, cause the computer system to install an application associated with the interactive content in response to the client device interacting with the interactive content.
